(19) United States
(12) Patent Application Publication
(10) Pub. No.: US 2026/0235113 A1
(43) Pub. Date: Aug. 13, 2026

(54) WIND TURBINE LUBRICATION SYSTEM

(71) Applicant: Vestas Wind Systems A/S, Aarhus N. (DK)

(72) Inventors: Mahendra Sonawane, Chennai (IN); Thomas Korsgaard Nielsen, Vejle (DK)

(73) Assignee: Vestas Wind Systems A/S, Aarhus N. (DK)

(21) Appl. No.: 19/475,137

(22) PCT Filed: Apr. 12, 2024
(86) PCT No.: PCT/DK2024/050090

§ 371 Date: Oct. 14, 2025

(30) Foreign Application Priority Data
Apr. 17, 2023 (DK) PA 2023 70179

(51) Int. Cl. F03D 80/70; F01M 1/02; F01M 1/10; F03D 80/55

(52) U.S. Cl. CPC F03D 80/707; F01M 1/02; F01M 1/10; F03D 80/55; F01M 2001/105; F05B 2260/98

(57) ABSTRACT

A wind turbine lubrication system (10) is described. The system (10) comprises a lubricant reservoir (12), a pump (16) for circulating lubricant from the lubricant reservoir (12) to a drivetrain component (14) of the wind turbine and back to the lubricant reservoir (12). A filter assembly (18) is connected between the lubricant reservoir (12) and the drivetrain component (14). A bypass channel (30) provides a fluid connection between the filter assembly (18) and the lubricant reservoir (12) that bypasses the drivetrain component (14). A fluid control device (20) is operable to select between a lubrication circuit and a cleaning circuit. The lubrication circuit comprises the lubricant reservoir (12), the filter assembly (18), and the drivetrain component (14). The cleaning circuit excludes the drivetrain component (14) and comprises the lubricant reservoir (12), the filter assembly (18) and the bypass channel (30). A method of servicing the lubrication system (10) comprises operating the fluid control device (20) to select the cleaning circuit. Lubricant is then circulated within the cleaning circuit during a cleaning cycle to remove contaminants from the lubricant.

### TECHNICAL FIELD

The present invention relates to a lubrication system for a wind turbine and to a method of servicing a lubrication system.

### BACKGROUND

Wind turbines are machines that convert wind energy into electricity. Like any mechanical system, wind turbines need proper lubrication to function optimally. Accordingly, wind turbines include a lubrication system that distributes a lubricating fluid to the drivetrain components, including the gearbox, bearings, shafts and other rotating or moving parts of the drivetrain.

The lubrication system includes a pump that distributes the lubricant from a reservoir to the drivetrain components through a series of pipes and hoses. Over time the lubricant will become contaminated by foreign particles including dust and debris. These particles must be removed from the lubricant otherwise they may cause excessive wear of the drivetrain components, reducing their useful life, or in extreme cases could damage the drivetrain components.

Accordingly, lubrication systems include a filter assembly designed to remove contaminants from the lubricant. The filter assembly typically includes a replaceable filter element that captures contaminants and prevents the contaminants from circulating within the system and reaching the drivetrain components.

The filter element is typically replaced at regular servicing intervals, for example every two years. Before the filter element can be replaced, the pump is stopped and the filter assembly must be drained of lubricant. Once the filter assembly has been emptied, the existing filter element is replaced with a new filter element. The pump is then restarted to recommence circulation of the lubricant through the system.

The condition of the lubricant may be monitored by sensors or by analysing samples of lubricant removed from the system. It has been found that the foreign particle count in the circulating lubricant significantly increases during the first few minutes after replacement of the filter element. This is thought to be caused by contaminants on the outside of the filter element coming loose when the filter element is removed. The problem may be exacerbated if the filter assembly has not been completely drained of lubricant before the filter element is replaced because then these loose contaminants mix with the lubricant in the filter assembly and subsequently are distributed directly to the drivetrain components after servicing of the filter has been completed and the pump restarted.

It is an object of the present invention to provide an improved lubrication system and an improved method of servicing a lubrication system, which reduces the level of contamination in the lubricant, which may increase the service life of the drivetrain components and/or prolong service intervals and/or generally improve the efficiency of the wind turbine drivetrain components.

### SUMMARY OF THE INVENTION

According to a first aspect of the present invention, there is provided a wind turbine lubrication system comprising: a lubricant reservoir; a pump for circulating lubricant from the lubricant reservoir to a drivetrain component of the wind turbine and back to the lubricant reservoir; a filter assembly connected between the lubricant reservoir and the drivetrain component, the filter assembly having an inlet side connected to the lubricant reservoir, an outlet side connected to the drivetrain component and a filter element arranged between the inlet side and the outlet side; and a bypass channel connected between the outlet side of the filter assembly and the lubricant reservoir, wherein the bypass channel provides a fluid connection between the outlet side of the filter assembly and the lubricant reservoir that bypasses the drivetrain component.

The bypass channel may be utilised during a cleaning cycle in which lubricant, typically oil, is circulated through the filter assembly whilst bypassing the drivetrain component. The cleaning cycle may be operated after replacement of the filter element during routine servicing of the lubrication system. Any contaminants in the filter assembly caused by replacement of the filter element may therefore be captured by the new filter element during the cleaning cycle and prevented from being distributed to the drivetrain components. The cleaning cycle may alternatively be operated at any other time when it may be desirable to clean the lubricant. For example, in the unlikely event of a component failure causing additional contamination in the lubricant the cleaning cycle may be operated to remove any contaminants from the lubricant. This may avoid the need to replace the lubricant in the event of excessive contamination.

The filter assembly may include one or more inlets on the inlet side and one or more outlets on the outlet side. Preferably the filter assembly comprises a single outlet. However, the filter assembly may alternatively include multiple outlets including a dedicated outlet to which the bypass channel is connected.

A first end of the bypass channel is connected to an outlet of the filter assembly. This may be a direct connection to the outlet. Alternatively, it may be an indirect connection. For example, the first end of the bypass channel may be connected anywhere along a conduit connecting the outlet side of the filter assembly to the drivetrain component. Preferably the first end of the bypass channel is connected near the outlet of the filter assembly.

A second end of the bypass channel is connected to the lubricant reservoir. This may be a direct connection to the reservoir. Alternatively, it may be an indirect connection. For example, the second end of the bypass channel may be connected to a conduit leading to the reservoir. Preferably the second end of the bypass channel is connected near an inlet of the reservoir.

The lubrication system preferably includes a fluid control device operable to select between a lubrication circuit and a cleaning circuit. The lubrication circuit is preferably a fluid circuit comprising the lubricant reservoir, the filter assembly, and the drivetrain component. The cleaning circuit is preferably a fluid circuit that excludes the drivetrain component and comprises the lubricant reservoir, the filter assembly and the bypass channel.

The lubrication system is preferably configured to circulate lubricant through the lubrication circuit during a lubrication cycle, and to circulate lubricant through the cleaning circuit during a cleaning cycle.

The fluid control device is preferably operable between first and second configurations. In the first configuration, the fluid control device permits lubricant to circulate within the lubrication circuit. In the second configuration, the fluid control device permits lubricant to circulate within the cleaning circuit and prevents lubricant from circulating within the lubrication circuit. Preferably, when in the first configuration, the fluid control device also prevents lubricant from circulating within the cleaning circuit. The first and second configurations may alternatively be referred to as first and second positions.

The fluid control device may comprise one or more valves. Preferably the fluid control device comprises a multi-way valve, more preferably a three-way valve. Preferably the fluid control device comprises a single valve operable between first and second positions to select either the lubrication circuit or the cleaning circuit. In the first position, a conduit leading from the outlet side of the filter assembly to the drivetrain component may be open, and the bypass channel may be blocked. In the second position, the conduit leading from the outlet side of the filter assembly to the drivetrain component may be blocked, and the bypass channel may be open.

In other examples, the fluid control device may comprise a plurality of valves. For example, the fluid control device may include a first valve within the lubrication circuit and a second valve within the cleaning circuit. The first valve preferably controls fluid flow from the outlet side of the filter assembly to the drivetrain component. The second valve preferably controls fluid flow through the bypass channel. Lubricant may be circulated within the lubrication circuit by opening the first valve, and lubricant may be circulated within the cleaning circuit by opening the second valve. Preferably the fluid control device is configured to close the first valve when the second valve is opened to prevent lubricant from circulating within the lubrication circuit when the cleaning cycle is selected. The fluid control device may also be configured to close the second valve when the first valve is opened such that bypass channel is blocked during the lubrication cycle.

The fluid control device preferably comprises a ball valve or other suitable valve. A ball valve is preferred because there is substantially no pressure loss across the valve.

The fluid control device may be manually operated. For example, it may comprise a valve having a handle that can be moved between multiple positions. In a first position the lubrication circuit may be selected. In a second position the cleaning circuit may be selected.

The fluid control device may be electrically actuated. Preferably the fluid control device is an electrically actuated valve, e.g. a motorised valve. The fluid control device, e.g. the one or more valves may alternatively or additionally be manually operable, for example by a handle, thereby allowing manual operation if needed.

The fluid control device may be remotely operable. For example, it may comprise a remotely controlled electrically actuated valve, such as a remotely operated motorised valve.

The use of remotely controlled valves enables the lubrication system to be remotely switched between the lubrication cycle and the cleaning cycle. This allows the cleaning cycle to be selected without a person needing to be physically present. For example, in the event that a high level of contamination should be detected in the lubricant then the cleaning cycle could be selected remotely to clean the lubricant.

The filter assembly may include a remotely operable drain valve for draining lubricant from the filter assembly. The drain valve is preferably connected to the lubricant reservoir so that lubricant drained from the filter assembly is returned to the lubricant reservoir.

The use of a remotely operable drain valve allows the filter assembly to be drained of lubricant without a person needing to be physically present at the filter, which is typically located within the nacelle of the wind turbine. For example, a service engineer tasked with replacing the filter element may remotely operate the drain valve to commence draining the lubricant when they arrive at the wind turbine, or whilst ascending the elevator or ladder to the nacelle. The lubricant may be substantially or completely drained by the time the service engineer reaches the filter assembly, allowing the filter element to be replaced immediately. Normally it can take fifteen minutes or more to drain the lubricant from the filter assembly, so the ability to open the drain valve remotely may significantly decrease the time required to service the lubrication system.

The bypass channel may be configured to provide a passage for air to enter the filter assembly when lubricant is drained from the filter assembly.

This allows pressure to equalise within the filter assembly during the draining process so that the lubricant can drain effectively. The bypass channel may provide a convenient means for air to enter the filter assembly.

The fluid control device may be remotely operated to select the cleaning circuit at the same time as the drain valve is remotely operated to drain the filter assembly. Selecting the cleaning circuit allows air to enter the filter assembly during the draining process so that pressure inside the filter assembly can equalise to facilitate or expedite draining of the lubricant.

A service engineer may therefore remotely operate both the drain valve and the fluid control device to select the cleaning circuit prior to physically attending the filter assembly such that the filter assembly is completely drained and ready for servicing immediately.

The pump may be configured to circulate lubricant through the lubrication circuit during the lubrication cycle. The pump is preferably also configured to circulate lubricant through the cleaning circuit during the cleaning cycle. Accordingly, the lubrication system may comprise a single pump. In other examples the lubrication system may comprise a plurality of pumps. For example, the lubrication circuit may include a first pump configured to circulate lubricant during the lubrication cycle, and the cleaning circuit may include a second pump configured to circulate lubricant during the cleaning cycle. The lubrication system may include one or more further pumps for reasons of redundancy or to provide additional pumping capacity where it is needed.

According to a second aspect of the present invention, there is provided a method of servicing a wind turbine lubrication system of the type described above. The method comprises operating the fluid control device to select the cleaning circuit, and circulating lubricant through the cleaning circuit during a cleaning cycle.

The method preferably comprises operating the cleaning cycle for several minutes.

The method may comprise exchanging the filter element with a replacement filter element prior to commencing the cleaning cycle.

The method may comprise draining lubricant from the filter assembly prior to exchanging the filter element.

The method may comprise remotely operating a drain valve of the filter assembly to commence draining of lubricant from the filter assembly.

The method may comprise remotely operating the drain valve prior to a service engineer reaching the location of the filter assembly, for example when the service engineer initially arrives at the wind turbine or is ascending the wind turbine in the elevator. By the time the service engineer reaches the filter assembly, the lubricant will have drained from the filter assembly and the filter element can immediately be replaced.

The method may comprise remotely operating the fluid control device to select the cleaning circuit.

After completion of the cleaning cycle, the method may further comprise operating the fluid control device to select the lubrication circuit, and continuously circulating lubricant through the lubrication circuit during a lubrication cycle.

The method may comprise replacing the pump after the cleaning cycle. For example, in the event that the lubricant should become heavily contaminated, for example if there has been a failure of a component causing a large amount of debris in the lubricant, then the cleaning cycle can be operated to circulate the lubricant through the bypass channel bypassing the drivetrain components. The pump may optionally be replaced after this process. Replacing the pump is simpler and cheaper than replacing the lubricant in the system. The cleaning cycle therefore can be utilised both during routine servicing of the filter element and in the event of a component failure to clean the lubricant without needing to replace the lubricant completely.

The method may comprise varying the speed of the pump during the cleaning cycle. The pump is preferably operated at its maximum speed during the cleaning cycle. Operating the pump at a high speed and/or at a varying speed creates turbulence during the cleaning cycle which helps to ensure contaminants within the lubricant are flushed through the cleaning circuit and trapped by the filter element.

In summary, a wind turbine lubrication system has been described. The system comprises a lubricant reservoir, a pump for circulating lubricant from the lubricant reservoir to a drivetrain component of the wind turbine and back to the lubricant reservoir. A filter assembly is connected between the lubricant reservoir and the drivetrain component. A bypass channel provides a fluid connection between the filter assembly and the lubricant reservoir that bypasses the drivetrain component. A fluid control device is operable to select between a lubrication circuit and a cleaning circuit. The lubrication circuit comprises the lubricant reservoir, the filter assembly, and the drivetrain component. The cleaning circuit excludes the drivetrain component and comprises the lubricant reservoir, the filter assembly and the bypass channel. A method of servicing the lubrication system comprises operating the fluid control device to select the cleaning circuit. Lubricant is then circulated within the cleaning circuit during a cleaning cycle to remove contaminants from the lubricant.

The present invention also provides a wind turbine having a lubrication system as defined above.

Preferred and optional features described above in relation to the invention when expressed in terms of a system apply equally to the invention when expressed in terms of a method, and vice versa. Repetition of these optional features is avoided purely for conciseness.

### BRIEF DESCRIPTION OF THE DRAWINGS

The invention will now be described, by way of non-limiting example, with reference to the accompanying figures, in which:

FIG. 1 shows a wind turbine incorporating a lubrication system according to an example of the present invention; and

FIG. 2 is a simplified piping and instrumentation diagram of a lubrication system according to an embodiment of the invention.

### DETAILED DESCRIPTION

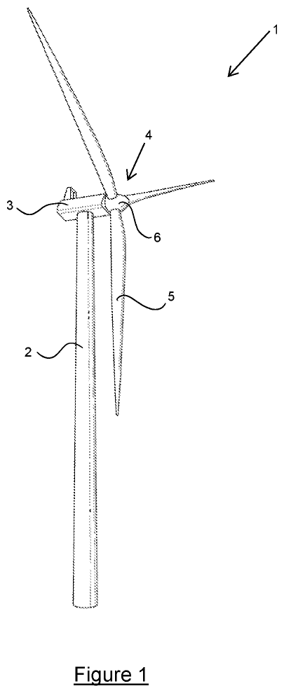

FIG. 1 shows a wind turbine 1 comprising a tower 2, a nacelle 3 supported at the top of the tower 2, and a rotor 4 mounted to the nacelle 3. The rotor 4 comprises a plurality of rotor blades 5 extending radially outwardly from a central hub 6. The nacelle 3 houses a number of components including a generator, which is connected to the rotor 4 by one or more shafts supported by bearings. The wind turbine 1 in this example also includes a gearbox connected between the rotor 4 and the generator. The gearbox is typically connected to the rotor via a low speed shaft, and connected to the generator via a high speed shaft. In some wind turbines, so-called ‘direct drive’ wind turbines, a gearbox is omitted.

The generator, gearbox (if present), shafts, bearings etc together comprise a drivetrain of the wind turbine 1.

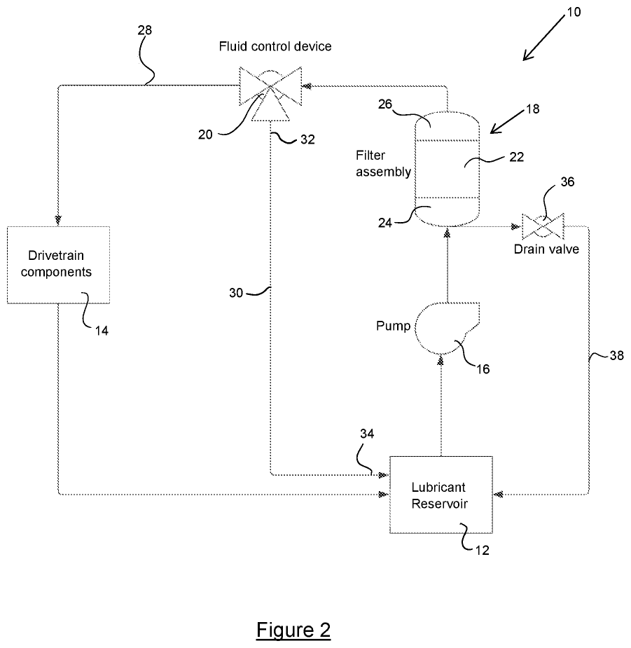

Referring to FIG. 2, this shows a wind turbine lubrication system 10 according to an embodiment of the present invention. The lubrication system 10 is configured to distribute lubricant from a lubricant reservoir 12 to one or more drivetrain components 14 of the wind turbine 1, for example a gearbox, bearings, shafts or other moving parts of the wind turbine drivetrain.

In addition to the lubricant reservoir 12, the lubrication system 10 shown in FIG. 2 includes a pump 16, a filter assembly 18 and a fluid control device 20, which are interconnected by pipes and/or hoses, represented by the arrows in FIG. 2, which also indicate the direction of lubricant flow within the system 10.

The lubricant reservoir 12 contains a supply of lubricant, for example oil. The lubricant reservoir 12 may comprise a tank sized to contain a substantial volume of lubricant. The lubricant reservoir 12 may contain 2500 litres or more of lubricant.

The pump 16 is configured to circulate the lubricant within the lubrication system 10 from the reservoir 12 to the drivetrain components 14 and back to the reservoir 12 in a continuous cycle. The pump 16 is preferably capable of pumping 800 litres per minute or more of lubricant around the system 10. Accordingly, an entire tank of lubricant may be circulated through the drivetrain components 14 approximately every three minutes in normal use.

Whilst the pump 16 in this example is shown connected between the reservoir 12 and the filter assembly 18, in other examples the pump 16 may be provided in a different position, for example downstream of the filter assembly 18. In further examples, the system 10 may include multiple pumps in different respective positions.

It is important that any contaminants in the lubricant are removed before the lubricant is supplied to the drivetrain components 14. Accordingly, the filter assembly 18 is arranged between the lubricant reservoir 12 and the drivetrain components 14. The filter assembly 18 includes a filter element 22 that captures and removes contaminants from the lubricant. The filter assembly 18 has an inlet side 24 and an outlet side 26. The inlet side 24 is connected to the lubricant reservoir 12, and the outlet side 26 is connected to the drivetrain component 14. The filter element 22 is arranged between the inlet side 24 and the outlet side 26. Lubricant from the reservoir 12 enters the filter assembly 18 through an inlet on the inlet side 24 and must pass through the filter element 22 before exiting the filter assembly 18 through an outlet on the outlet side 26. Any contaminants in the lubricant are removed by the filter element 22 when the lubricant passes through the filter assembly 18. The fluid control device 20 is arranged within a conduit 28 connecting the outlet side 26 of the filter assembly 18 to the drivetrain components 14. Alternatively, the fluid control device 20 could be directly attached to the outlet of the filter assembly 18. The fluid control device 20 is operable to control the flow of lubricant within the lubrication system 10 as will be discussed in more detail below.

The lubrication system 10 includes a bypass channel 30. The bypass channel 30 provides a fluid connection between the outlet side 26 of the filter assembly 18 and the lubricant reservoir 12 that bypasses the drivetrain component 14. In this example, a first end 32 of the bypass channel 30 is connected to the fluid control device 20. A second end 34 of the bypass channel 30 is connected to the lubricant reservoir 12, either directly or via a conduit extending to the lubricant reservoir 12. Preferably the bypass channel 30 provides a direct connection between the filter assembly 18 and the reservoir 12, i.e. a direct return path for lubricant exiting the filter assembly 18 and returning to the reservoir 12.

The fluid control device 20 is operable to select between a lubrication circuit and a cleaning circuit. The lubrication circuit is a fluid circuit comprising the lubricant reservoir 12, the filter assembly 18, and the drivetrain component 14. The cleaning circuit is a fluid circuit comprising the lubricant reservoir 12, the filter assembly 18 and the bypass channel 30. The cleaning circuit excludes the drivetrain components 14, i.e. it bypasses the drivetrain components 14.

In this example, the fluid control device 20 comprises a three-way valve. Preferably the fluid control device 20 is a three-way ball valve.

In a first position, the valve 20 provides a fluid communication passage between the filter assembly 18 and the drivetrain components 14 whilst blocking the bypass channel 30. Accordingly, when the pump 16 is operated with the valve 20 in its first position, lubricant is circulated in the lubrication circuit, from the reservoir 12, through the filter assembly 18, to the drivetrain components 14 and then back to the reservoir 12.

In a second position, the valve 20 opens the bypass channel 30 whilst blocking the passage of lubricant from the filter assembly 18 to the drivetrain components 14. Accordingly, when the pump 16 is operated with the valve 20 in its second position, lubricant is circulated in the cleaning circuit, from the reservoir 12, through the filter assembly 18, and back to the reservoir 12 through the bypass channel 30, thereby bypassing the drivetrain components 14.

It is necessary to change the filter element 22 in the filter assembly 18 at regular intervals, for example every two years. Prior to replacing the filter element 22, the wind turbine is stopped and the pump 16 in the lubrication system 10 is shut down to prevent lubricant circulating within the system 10. The filter assembly 18 is then completely drained of lubricant by opening a drain valve 36 in a conduit 38 connecting the filter assembly 18 to the reservoir 12. Once all the lubricant has been drained from the filter assembly 18, the filter element 22 may be removed and replaced with a new filter element. The pump 16 may be reactivated to resume the circulation of lubricant within the system 10.

The process of changing the filter element 22 can result in increased contamination in the lubricant. This can be caused by contaminants becoming dislodged from the old filter element 22 when it is removed. Indeed, it has been found that the level of contamination in the system 10 can increase significantly during the first few minutes after replacing the filter element 22.

In traditional lubrication systems, which do not include a bypass channel 30, these contaminants may be distributed directly to the drivetrain components 14 when the pump 16 is reactivated after replacing the filter elements. This can result in sensitive components in the drivetrain becoming damaged or incurring excessive wear, thus reducing the service life of these components.

By way of the present invention, these contaminants may be removed from the lubricant during a cleaning cycle activated after the filter element 22 is replaced. Accordingly, prior to removal of the filter element 22, the flow control device is set in its second position to open the bypass channel 30 and block the line connecting the filter assembly 18 to the drivetrain component 14. When the pump 16 is reactivated after replacing the filter element 22, the lubricant is circulated in the cleaning circuit, which bypasses the drivetrain components 14. Specifically, the lubricant is calculated from the reservoir 12, through the filter assembly 18 with its new filter element 22, and back to the reservoir 12 through the bypass channel 30.

The cleaning cycle may be operated for several minutes, such that substantially all the lubricant in the system 10 is circulated through the new filter element 22 multiple times. This process very effectively removes a significant amount if not all the contaminants in the lubricant after the filter is replaced and before the lubricant is distributed to the drivetrain components 14.

At the end of the cleaning cycle, the fluid control device 20 is moved to its first position, which blocks the bypass channel 30 and opens the line connecting the filter assembly 18 to the drivetrain components 14. The clean lubricant is then circulated within the lubricant circuit and through the drivetrain components 14, and the wind turbine can be restarted.

As well as being utilised immediately after filter elements are exchanged, the cleaning cycle may also advantageously be used at any other time to clean the lubricant. For example, in the event of high levels of contamination in the lubricant for any reason, the cleaning cycle may be activated to provide additional filtering of the lubricant. High levels of contamination may arise if a component wears excessively or fails completely.

In the very rare cases of a component failure, a large quantity of metal particles or other debris may contaminate the lubricant. Normally it is then required to shut down the wind turbine and change the lubricant. Replacing the lubricant is a significant task, considering the large volume of lubricant that must be drained from the system 10, disposed of and replaced. This process is made even more difficult as the lubrication system 10 is typically located within the wind turbine nacelle 3, which may be located at the top of a very high tower 2, and at sea in the case of offshore turbines.

The need to replace the lubricant may be avoided with the present invention. Instead it may be possible to clean the existing lubricant to remove all the harmful contaminants by activating the cleaning cycle. The drivetrain components 14 are protected during this process since they are bypassed. After cleaning the lubricant, the filter element 22 may be replaced. Also, it may be necessary to replace the pump 16 if this has incurred damage during the cleaning process. However, replacing the pump 16 is a relatively simple and inexpensive operation in comparison to replacing all the lubricant. Any downtime of the wind turbine may therefore be significantly reduced. Accordingly, the ability to clean the lubricant in this way presents a significant benefit in terms of efficiency and cost savings.

In a particularly advantageous configuration, the flow control device is remotely operable, for example it may comprise a remotely controlled electrically-actuated valve. This advantageously allows the cleaning cycle to be activated even without a service engineer needing to be physically present at the wind turbine. For example, the system 10 may include sensors for determining a level of contamination in the lubricant and the cleaning cycle may be activated to provide additional filtering of the lubricant in the event that contamination levels exceed a particular level.

The system 10 may be configured to generate turbulence within the filer assembly during the cleaning cycle to help flush out contaminants. For example, the pump 16 may be configured to operate at a higher speed than normal during the cleaning cycle. Alternatively, or additionally, the pump 16 may be configured to operate at a variable speed during the cleaning cycle. Both options increase the turbulent flow of the lubricant and increase the efficiency of the filtering process.

In a particularly advantageous configuration, the drain valve 36 is remotely operable, for example it may be a remotely controlled electrically-actuated valve. This allows the filter assembly 18 to be drained of lubricant without a person being in physical attendance at the filter assembly 18. For example, it would allow a service engineer to prepare the filter assembly 18 for filter replacement before the service engineer arrives at the wind turbine, or whilst the service engineer is ascending the turbine tower 2 by a ladder or elevator. As draining the lubricant is relatively time-consuming, the ability to drain the lubricant before arriving at the filter assembly 18 presents a significant benefit and reduces the time required for servicing the system 10.

The bypass channel 30 may be configured to allow air to enter the filter assembly 18 when the flow control device is set to the second position, i.e. when the cleaning circuit is selected. When the filter assembly 18 is drained of lubricant, air may then enter the filter assembly 18 via the bypass channel 30 so that pressures can equalise within the filter assembly 18 and allowing the lubricant to escape through the drain valve 36. The bypass conduit 30 may be sized to contain a sufficient volume of air or may include a vent to facilitate this process.

The combination of a remotely operable fluid control device 20 and a remotely operable drain valve 36 is particularly advantageous. This allows the service engineer to remotely operate both valves so that the lubricant can drain efficiently from the filter assembly 18 with air being admitted into the filter assembly 18 through the bypass channel 30.

It will be appreciated from the above description that the present invention presents a number of advantages over prior art lubrication systems. In particular, by way of the bypass channel 30 and cleaning cycle, foreign particles entrapped in the system 10 during filter removal are caught in the new filter instead of being distributed directly to the gearbox or other drivetrain components 14. Foreign particles downstream of the filter are therefore avoided. This results in contamination-free lubricant, which will increase the life of the gearbox and other drivetrain components 14, and avoid excessive wear or failure of the components. The system 10 also can prolong service intervals and improves the efficiency of the wind turbine drivetrain components 14 because it enables the lubricant to be cleaned as required to remove contaminants that might otherwise damage the drivetrain components 14.

Many modifications may be made to the above example without departing from the scope of the present invention as defined in the following claims. Many such modifications and variants have been described in the “Summary of the invention” section above.

1. A wind turbine lubrication system comprising:
a lubricant reservoir;
a pump for circulating lubricant from the lubricant reservoir to a drivetrain component of the wind turbine and back to the lubricant reservoir;
a filter assembly connected between the lubricant reservoir and the drivetrain component, the filter assembly having an inlet side connected to the lubricant reservoir, an outlet side connected to the drivetrain component, and a filter element arranged between the inlet side and the outlet side; and
a bypass channel connected between the outlet side of the filter assembly and the lubricant reservoir, wherein the bypass channel provides a fluid connection between the outlet side of the filter assembly and the lubricant reservoir that bypasses the drivetrain component.

2. The wind turbine lubrication system of claim 1, further comprising:
a fluid control device operable to select between a lubrication circuit and a cleaning circuit,
wherein the lubrication circuit is a fluid circuit comprising the lubricant reservoir, the filter assembly, and the drivetrain component, and
wherein the cleaning circuit is a fluid circuit that excludes the drivetrain component and comprises the lubricant reservoir, the filter assembly and the bypass channel.

3. The wind turbine lubrication system of claim 1, wherein the pump is configured to circulate lubricant through the lubrication circuit during a lubrication cycle and through the cleaning circuit during a cleaning cycle.

4. The wind turbine lubrication system of claim 1, wherein the fluid control device comprises one or more valves.

5. The wind turbine lubrication system of claim 1, wherein the fluid control device is electrically actuated.

6. The wind turbine lubrication system of claim 1, wherein the fluid control device is remotely operable.

7. The wind turbine lubrication system of claim 1, wherein the filter assembly further comprises a remotely operable drain valve for draining lubricant from the filter assembly.

8. The wind turbine lubrication system of claim 1, wherein the bypass channel is configured to provide a passage for air to enter the filter assembly when lubricant is drained from the filter assembly.

9. A method of servicing the wind turbine lubrication system of claim 2, the method comprising:
operating the fluid control device to select the cleaning circuit, and
circulating lubricant through the cleaning circuit during a cleaning cycle.

10. The method of claim 9, further comprising exchanging the filter element with a replacement filter element prior to commencing the cleaning cycle.

11. The method of claim 10, further comprising draining lubricant from the filter assembly prior to exchanging the filter element.

12. The method of claim 11, further comprising remotely operating a drain valve of the filter assembly to commence draining of lubricant from the filter assembly.

13. The method of claim 9, further comprising remotely operating the fluid control device to select the cleaning circuit.

14. The method of claim 9, wherein after completion of the cleaning cycle, the method further comprises:
operating the fluid control device to select the lubrication circuit, and
continuously circulating lubricant through the lubrication circuit during a lubrication cycle.

15. The method of claim 9, further comprising replacing the pump after the cleaning cycle.

16. The method of claim 9, further comprising varying the speed of the pump during the cleaning cycle.
